(19) United States
(12) Patent Application Publication
(10) Pub. No.: US 2005/0094790 A1
(43) Pub. Date: May 5, 2005

(54) Transmission of user input(s) to telephony device(s) through employment of data stream(s) associated with call

(76) Inventor: Edward Alan Clark, Sugar Grove, IL (US)

Correspondence Address: PATTI & BRILL, ONE NORTH LASALLE STREET, 44TH FLOOR, CHICAGO, IL, 60602, US

(21) Appl. No.: 10/698,328

(22) Filed: Oct. 31, 2003

(51) Int. Cl. H04M 3/42

(52) U.S. Cl. 379/201.01

(57) ABSTRACT

One or more application server components cooperate to transmit one or more user inputs to one or more telephony devices on a call through employment of one or more data streams associated with the call.

### CROSS-REFERENCE TO RELATED APPLICATIONS

This application contains subject matter which is related to the subject matter of the following applications, which are assigned to the same assignee as this application. The below-listed applications are hereby incorporated herein by reference in their entireties:

“DATA STREAM ASSOCIATION WITH CALL THROUGH EMPLOYMENT OF IDENTIFIER WITHIN MESSAGES ASSOCIATED WITH THE CALL,” by Clark, et al., co-filed herewith.

“SERVICE(S) PROVIDED TO TELEPHONY DEVICE(S) THROUGH EMPLOYMENT OF DATA STREAM(S) ASSOCIATED WITH THE CALL,” by Edward A. Clark, co-filed herewith.

“SERVICE(S) PROVIDED TO TELEPHONY DEVICE THROUGH EMPLOYMENT OF DATA STREAM(S) ASSOCIATED WITH CALL,” by Edward A. Clark, co-filed herewith.

### TECHNICAL FIELD

The invention relates generally to telecommunications and more particularly to enabling telephony devices associated with a call to interact through employment of data streams associated with the call.

### BACKGROUND

A user of Customer Premise Equipment (“CPE”) initiates a call on a network. The CPE in one example comprises a telephony device. The CPE in one example employs a call request signaling, for example, a Dual Tone Multi Frequency (“DTMF”) protocol, to initiate the call.

The user of the calling CPE in one example initiates the call to a user of a called CPE. The user of the calling CPE and the user of the called CPE cooperate and interact through employment of one or more messages. In one example, the user of the calling CPE and the user of the called CPE employ one or more touch-tones to interact. In another example, the user of the calling CPE and the user of the called CPE interact through voice commands.

The interactions between CPEs are limited by the information provided in the messages received from network elements, such as an application server and/or switch, associated with the call. For example, the interactions are limited to the information provided through the touch-tones or voice commands. As one shortcoming, the restriction of the interactions to the CPEs by the information provided in the messages associated with the call undesirably limits the types of interactions available to the users of the CPEs.

Thus, a need exists to allow the users of the CPEs on the call to interact outside of the messages associated with the call. Another need exists to reduce limitations on one or more interactions available to users of the CPEs relative to information present in the one or more messages received from the network.

### SUMMARY

The invention in one embodiment encompasses an apparatus. One or more application server components cooperate to transmit one or more user inputs to one or more telephony devices on a call through employment of one or more data streams associated with the call.

Another embodiment of the invention encompasses a method. One or more user inputs are transmitted to one or more telephony devices on a call through employment of one or more data streams associated with the call.

Yet another embodiment of the invention encompasses an article. The article comprises one or more computer-readable signal-bearing media. The article comprises means in the one or more media for transmitting one or more user inputs to one or more telephony devices on a call through employment of one or more data streams associated with the call.

### DESCRIPTION OF THE DRAWINGS

Features of exemplary implementations of the invention will become apparent from the description, the claims, and the accompanying drawings in which:

FIG. 1 is a representation of one exemplary implementation of an apparatus that comprises one or more application server components, one or more switch components, one or more telephony devices, and one or more networks.

FIG. 2 is a representation of an exemplary process flow of an establishment of a data stream between a first application server component and a second application server component of the apparatus of FIG. 1.

FIG. 3 is a representation of an exemplary message employed in establishment of the data stream by the application server component and the switch component of the apparatus of FIG. 1.

FIG. 4 is a representation of another exemplary message employed in establishment of the data stream by the application server component and the switch component of the apparatus of FIG. 1.

FIG. 5 is a representation of yet another exemplary message employed in establishment of the data stream by the application server component and the switch component of the apparatus of FIG. 1.

### DETAILED DESCRIPTION

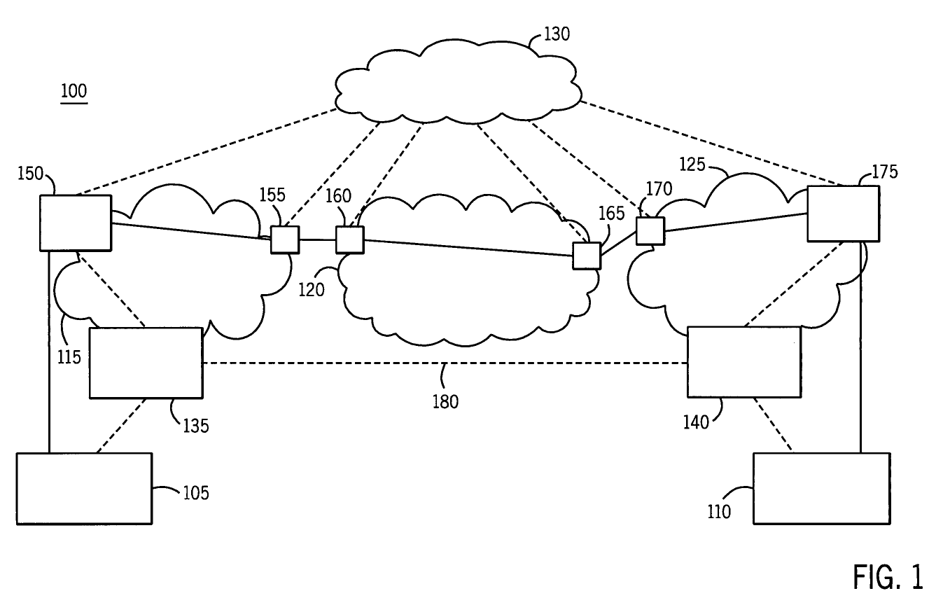

Turning to FIG. 1, an apparatus 100 in one example comprises one or more telephony devices 105 and 110, and one or more networks 115, 120, 125, and 130. The telephony devices 105 and 110 in one example comprise one or more Customer Premise Equipments (“CPEs”), such as a computer, a web-enabled device, and/or a telephone. The telephony devices 105 and 110 initiate and/or receive one or more calls. In one example, the telephony device 105 initiates a call to the telephony device 110. In another example, the telephony device 105 receives a call initiated by the telephony device 110.

The telephony devices 105 and 110 initiate calls through employment of a call request signaling. The call request signaling in one example comprises a Dual-Tone Multi-Frequency (“DTMF” or Touch Tone) signaling, as will be understood by those skilled in the art. The telephony device 105 and 110 initiate the calls on the networks 115, 120, 125, and/or 130.

The networks 115, 120, and 125 in one example comprise one or more service provider networks. In one example, the networks 115, 120, and 125 comprise a Public Switched Telephony Network (“PSTN”) and/or an Integrated Services Digital Network (“ISDN”). The network 130 in one example comprises a signaling network, for example, a Signaling System 7 (“SS7”) network. The networks 115, 120, 125, and 130 in one example comprise one or more application server components 135, 140, and 145 and one or more switch components 150, 155, 160, 165, 170, and 175.

One or more of the networks 115, 120, 125, and 130 communicate with one or more other of the networks 115, 120, 125, and/or 130 through employment of one or more call control protocols. The one or more call control protocols in one example comprises an Integrated Services Digital Network User Part (“ISUP”) protocol, the Session Initiation Protocol (“SIP”), the Bearer Independent Call Control (“BICC”) protocol, and the Transaction Capabilities Application Part (“TCAP”) protocol. The networks 115, 120, 125, and/or 130 establish calls from the telephony device 105 to the telephony device 110.

The application server components 135 and/or 140 comprise one or more application servers. The application server component 135 and/or 140 in one example comprise user-related application server components. The application server components 135 and/or 140 in one example comprise Customer Premise Equipment (“CPE”). One or more of the application server components 135 and/or 140 communicate with one or more other of the application server components 135 and/or 140 through employment of one or more data stream control protocols. The data stream control protocols in one example comprise one or more of the User Datagram Protocol (“UDP”), the Transfer Control Protocol (“TCP”), and/or the Session Initiation Protocol (“SIP”).

One or more of the application server components 135, 140, and/or 145 communicate with one or more of the one or more switch components 150, 155, 160, 165, 170, and/or 175 through employment of one or more service control protocols. The service control protocol in one example comprises the Session Initiation Protocol (“SIP”). The application server components 135 and 145 in one example communicate with the switch components 150 and 175 respectively.

The switch components 150, 155, 160, 165, 170, and/or 175 in one example comprise one or more telephony switches, for example, one or more Service Switching Points (“SSPs”). The switch components 150, 155, 160, 165, 170, and/or 175 communicate with the telephony devices 105 and/or 110 through employment of the call request signaling. The switch components 150, 155, 160, 165, 170, and/or 175 and the telephony devices 105 and/or 110 cooperate to establish a call. The switch components 150, 155, 160, 165, 170, and/or 175 communicate with one or more other of the switch components 150, 155, 160, 165, 170, and/or 175 through employment of one or more of the one or more call control protocols.

In one example, the switch components 150, 155, 160, 165, 170, and/or 175 employ one or more messages 502 (FIG. 5), for example, one or more initiation messages, to establish a call. In another example, the switch components 150, 155, 160, 165, 170, and/or 175 employ one or more messages 602 (FIG. 6), for example, one or more request-back messages during establishment of the call. The messages 502 and the messages 602 in one example conform to the call control protocol.

The application server components 135 and/or 140 establish one or more data streams, for example, a data stream 180 with one or more other of the application server components 135 and 140. The application server components 135 and/or 140 associate the data stream 180 with calls. The application server components 135 and/or 140 employ the data stream 180 to provide one or more interactions for calls.

The application server components 135 and/or 140 establish the data stream 180 through employment of one or more identifiers 505 (FIG. 5), 605 (FIG. 6) and/or 705 (FIG. 7). The application server components 135 and/or 140 employ the identifiers 505, 605, and/or 705 to associate the data stream with calls. The identifiers 505, 605, and/or 705 comprise information to distinguish one call from another call associated with the application server components 135 and/or 140.

An identifier 505 in one example comprises a network address 510, a port 515, and an identification tag 520. The network address 510 in one example comprises an Internet Protocol (“IP”) address associated with one of the application server components 135 and/or 140. The port 515 comprises a port number, for example, port 8080, associated with one of the application server components 135 and/or 140. The port 515 in one example is associated with the one or more interactions available from the application server components 135 and/or 140 for a call. The identification tag 520 serves to uniquely identify the call, as will be appreciated by those skilled in the art.

The application server components 135 and/or 140 establish the data stream 180 through employment of one or more messages 702 (FIG. 7), for example, one or more data stream request messages. Wherein a message 702 comprises a data stream request message, the application server components 135 and/or 140 provide a portion of the identifier 505 within the message 702. The message 702 conforms to one or more of the data stream control protocols.

Referring to FIGS. 5-7, the message 502 and 602 conform to the call control protocol. The message 702 conforms to the data stream request protocol. The messages 502, 602, and 702 comprise one or more generic parameters 507, 607, and 707. The generic parameters 507 and 607 in one example comprise one or more Generic Address Parameters (“GAPs”).

The message 502 in one example comprises the initiation message. The message 502 comprises the generic parameter 507. The generic parameter 507 in one example comprises the identifier 505. The switch component 150 and the application server component 135 in one example provide the identifier 505 within the generic parameter 507.

The message 602 in one example comprises a request-back message. The message 602 comprises the generic parameter 607. The generic parameter 607 in one example comprises the identifier 605. The identifier 605 in one example comprises a network address 610, a port 615, and an identification tag 620.

The message 702 in one example comprises a data stream request message. The message 702 comprises a portion of an identifier, for example, the identifier 505, within the generic parameter 707 of the message 702. The generic parameter 707 comprises a port 715 and an identification tag 720. In one example, the port 715 comprises the port 515 or 615. In another example, the identification tag 720 comprises the identification tag 520 or 620. The application server component 135 in one example routes the message 702 to a network address 710.

In one example, the network address 710, the port 715, and the identification tag 720 comprise the network address 510, the port 515, and the identification tag 520. In another example, the network address 710, the port 715, and the identification tag 720 comprise the network address 610, the port 615, and the identification tag 620.

The application server components 135 and/or 140 associate a call with the identifiers 505 of a plurality of identifiers 505 and/or identifier 605 of a plurality of identifier 605. The application server components 135 and/or 140 in one example select the identifier 505 and/or 605 from the plurality of identifiers 505 and/or 605 such that the identifier 505 and/or 605 uniquely identifies the call. For example, the application server component 135 selects a first identifier 505 to associate with a first call, and a second identifier 505 to associate with a second call. The application server component 135 distinguishes the first call from the second call through employment of the first identifier 505 and the second identifier 505, as will be appreciated by those skilled in the art.

In one example, the application server component 135 selects the identifier 505 and/or 605 from the plurality of identifiers 505 and/or 605 available for the call through employment of a random selection method. In another example, the application server component 135 employs a static selection method to select the identifier 505 and/or 605. In yet another example, the application server component 135 employs a priority selection method to select the identifier 505 and/or 605. In still yet another example, the application server component 135 selects the identifier 505 and/or 605 based on information associated with a call provided by the switch component 150.

For example, where the application server component 135 selects the identifier 505, the application server component 135 selects: the network address 510 of a plurality of network addresses 510 associated with the application server component 135; the port 515 of a plurality of ports 515 associated with the application server component 135; and the identification tag 520 of a plurality of identification tags 520 associated with the application server component 135.

In another example, the application server component 140 associates the identifier 505 with a call through employment of the message 502, for example, the initiation message. For example, the message 502 associated with the call comprises the identifier 505. Upon receipt of the message 502, the switch component 175 communicates with the application server component 140 to provide the identifier 505 to the application server component 140. The application server component 140 stores the identifier 505.

The application server components 135 and/or 140 in one example associate the data stream 180 with calls through employment of the identifiers 505 and/or 605. The application server components 135 and/or 140 in one example employ the identifier 505 to distinguish a first data stream, for example, a first instance of the data stream 180, associated with the first call from a second data stream, for example, a second instance of the data stream 180, associated with the second call.

For example, the application server component 135 associates the first call with the first identifier 505. The application server components 135 and 140 cooperate to establish the first instance of the data stream 180 associated with the first call. The application server component 140 associates the second call with the second identifier 505. The application server components 135 and 140 cooperate to establish the second instance of the data stream 180 associated with the second call. The application server components 135 and/or 140 employ the first identifier 505 and the second identifier 505 to distinguish the first instance of the data stream 180 associated with the first call from the second instance of the data stream 180 associated with the second call.

The application server components 135 and/or 140 transmit the one or more user inputs through employment of the data stream 180. In another example, the application server components 135 and/or 140 in one example cooperate to provide one or more interactions available to the telephony device 110. In another example, the application server components 135 and/or 140 transfer data related to the one or more interactions available to the telephony device 110.

In one example, upon establishment of the data stream 180, the application server components 135 and/or 140 allow the telephony device 105 and the telephony device 110 to interact. The telephony devices 105 and/or 110 interact with the other of the telephony devices 105 and/or 110 by initiating one or more user inputs, for example, a data transfer or an authorization request associated with a call. The telephony devices 105 and/or 110 perform the user inputs through employment of the one or more web portals established with the application server component 135 and/or 140. The application server components 135 and/or 140 transmit the user inputs to the telephony devices 105 and/or 110 through employment of the data stream 180.

In another example, the application server components 135 and/or 140 transfer data to form one or more interfaces associated with the one or more interactions available to the telephony devices 105 and/or 110. For example, the application server component 140 transfers data to form an interface to the application server component 135. The interfaces in one example comprise one or more eXtended Markup Language (“XML”) interfaces. The application server components 135 and/or 140 employ one or more internet protocols such as HyperText Transfer Protocol (“HTTP”) to provide the interfaces to the telephony devices 105 and/or 110. The telephony devices 105 and/or 110 employ the one or more interfaces to initiate the user inputs.

The application server components 135 and/or 140 in one example transmit the user inputs on a call-by-call basis through employment of the identifier 505. The application server components 135 and/or 140 associate the one or more web portals with a call through employment of the identifier 505 and/or 605. The application server components 135 and/or 140 in one example employ the identifier 505 to distinguish a first one or more user inputs associated with the first call from a second one or more interactions associated with the second call. For example, the application server component 135 employs the first identifier 505 to provide the first one or more interactions through employment of the data stream 180. The application server component 135 employs the second identifier 505 to provide the second one or more interactions through employment of the data stream 180.

To establish a call, the switch components 150, 155, 160, 165, 170, and/or 175 employ the message 502, for example, the initiation message, and/or the message 602, for example, the request-back message. The Integrated Services Digital Network User Part protocol comprises the message 502, for example, an Initial Address Message (“IAM”), and the message 602, for example, a Call ProGress (“CPG”) message. The switch components 150, 155, 160, 165, 170, and/or 175 provide the identifier 505 and/or 605 within the messages 502 and/or 602 associated with the call. The switch components 150, 155, 160, 165, 170, and/or 175 associate the call with the identifier 505 and/or 605. The switch components 150, 155, 160, 165, 170, and/or 175 cooperate with the application server components 135 and 140 to transmit the one or more user inputs for the call.

The switch components 150, 155, 160, 165, 170, and/or 175 provide the identifier 505 within the message 502 and/or the identifier 605 within the message 602 associated with a call. In one example, the switch component 150 inserts the identifier 505 into the generic parameter 507 of the message 502. In another example, switch component 175 inserts the identifier 605 into the generic parameter 607 of the message 602. For example, the switch component 150 is pre-provisioned to communicate with the application server component 135 upon receipt of the message 502, and/or message 602, where the message 502 comprises the initiation message, and/or the message 602 comprises the request-back message. The switch component 150 provides the identifier 505 from within the message 502 and/or the message 602 to the application server component 135. In another example, the switch component 175 is pre-provisioned to communicate with the application server component 140 to obtain the identifier 505 upon sending of the message 502 and/or the message 602 from the switch component 175.

The message 502, for example, the initiation message, is received by the switch component 175. Where the message 502 omits the identifier 505, the switch component 175 communicates with the application server component 140 to obtain the identifier 605. The switch component 175 inserts the identifier 605 into the message 602, for example, the request-back message. The switch component 175 sends the message 602 to the switch component 150.

The switch components 150, 155, 160, 165, 170, and/or 175 associate the identifier 505 with a call. The switch components 150, 155, 160, 165, 170, and/or 175 associate the identifier 505 with the call through employment of the message 502. For example, the switch component 150 associates the identifier 505 with the call established by the message 502 through employment of the message 502.

Where a user of the telephony device 105 establishes a call, the switch components 150, 155, 160, 165, 170, and/or 175 cooperate with the application server components 135 and/or 140 to establish the data stream 180 associated with the call. Where the user of the telephony device 105 performs a user input associated with the call, for example, initiates a transfer of a purchase order, the application server components 135 and/or 140 and the switch components 150 and/or 175 cooperate to transfer user input (e.g., the purchase order) to the telephony device 110 through employment of the data stream 180 associated with the call.

An illustrative description of exemplary operation of the apparatus 100 is presented, for explanatory purposes.

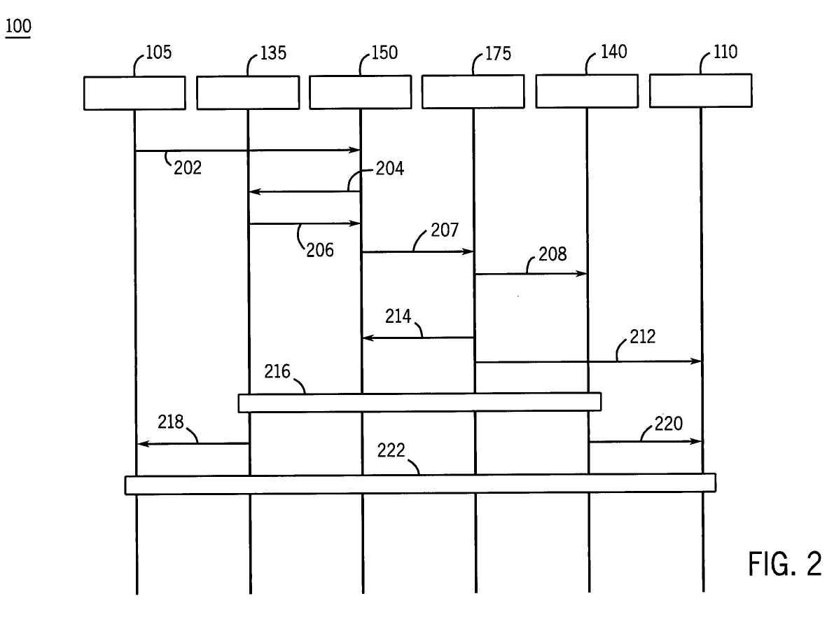

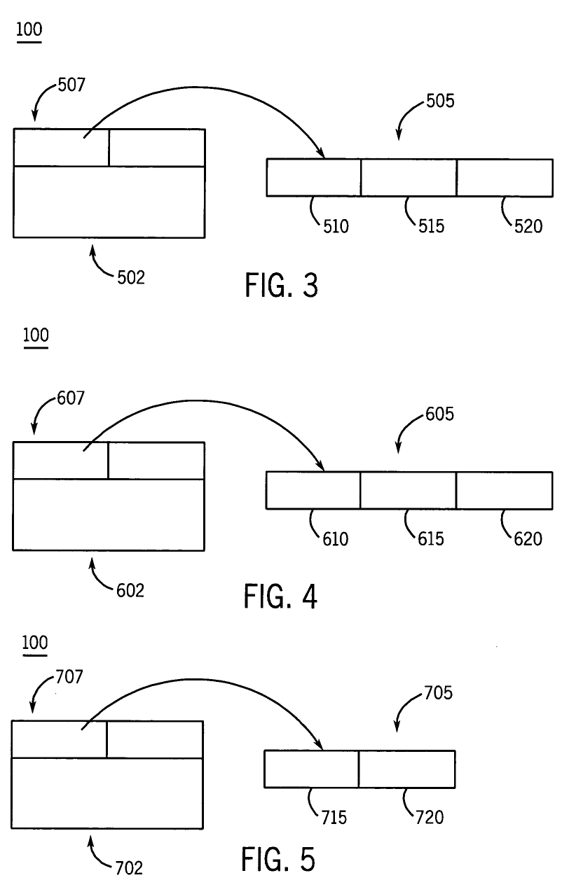

Turning to FIG. 2, a user of the telephony device 105 initiates a call to the telephony device 110. The switch component 150 is pre-provisioned to communicate with the application server component 135. The switch component 175 is pre-provisioned to communicate with the application server component 140.

In STEP 202, the user of the telephony device 105 dials the number of the telephony device 110. In STEP 204, the switch component 150 communicates with the application server component 135 to obtain the identifier 505 associated with the call. In STEP 206, the application server component 135 provides the identifier 505 to the switch component 150. In STEP 207, the switch component 150 routes the message 502 (e.g., the Initial Address Message) to the switch component 175.

In STEP 208, the switch component 175 provides the identifier 505 from within the message 502 to the application server component 140. In STEP 212, the switch component 175 offers the call to the telephony device 110 through employment of line signaling (e.g., power ringing). In STEP 214, the switch component 175 initiates indicates call delivery with a message, for example, an ANSI Address Complete Message (“ACM”), to the switch component 150.

In STEP 216, the application server component 140 initiates the data stream request message 702 to the application server component 135. The application server components 135 and 140 cooperate to establish the data stream 180. In STEP 218, the application server component 135 establishes a first one or more web portals with the telephony device 105. In STEP 220, the application server component 140 establishes a second one or more web portals with the telephony device 110.

In STEP 222, the telephony device 110 performs a user input, for example, a request for authorization, to the telephony device 105 through employment of one or more of the web portals. The application server components 135 and 140 cooperate to transmit the user input from the telephony device 110 to the telephony device 105 through employment of the data stream 180.

The apparatus 100 in one example comprises a plurality of components such as computer software and/or hardware components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art.

The apparatus 100 employs at least one computer-readable signal-bearing medium. One example of a computer-readable signal-bearing medium for the apparatus 100 comprises an instance of a recordable data storage medium such as one or more of a magnetic, electrical, optical, biological, and atomic data storage medium. The recordable data storage medium in one example comprises the storage device 101. In another example, a computer-readable signal-bearing medium for the apparatus 100 comprises a modulated carrier signal transmitted over a network comprising or coupled with the apparatus 100, for instance, one or more of a telephone network, a local area network (“LAN”), the internet, and a wireless network. An exemplary component of the apparatus 100 employs and/or comprises a set and/or series of computer instructions written in or implemented with any of a number of programming languages, as will be appreciated by those skilled in the art.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An apparatus, comprising:
one or more application server components that transmit one or more user inputs to one or more telephony devices on a call through employment of one or more data streams associated with the call.

2. The apparatus of claim 1, wherein the one or more application server components cooperate with the one or more telephony devices to establish one or more web portals that are employable by the one or more telephony devices to initiate the one o or more user inputs.

3. The apparatus of claim 2, wherein the one or more application server components employ the one or more web portals to receive the one or more user inputs from the one or more telephony devices.

4. The apparatus of claim 2, wherein the one or more application server components associate the one or more web portals with the one or more data streams.

5. The apparatus of claim 2, wherein the one or more application server components provide one or more interfaces through employment of the one or more web portals for employment by the one or more telephony devices to initiate the one or more user inputs.

6. The apparatus of claim 2, wherein the one or more application server components employ an internet protocol to establish the one or more web portals.

7. The apparatus of claim 6, wherein the internet protocol comprises a HyperText Transport Protocol (HTTP);
wherein the one or more application server components employ the HyperText Transport Protocol to establish the one or more web portals.

8. The apparatus of claim 1, wherein the one or more application server components allow the one or more telephony devices to interact through employment of the one or more data streams

9. The apparatus of claim 8, wherein the one or more application server components employ the one or more data streams to transfer data related to one or more interactions available to the one or more telephony devices;
wherein the one or more application server components provide the one or more interactions to the one or more telephony devices for employment by the one or more telephony devices to interact with one or more of the one or more telephony devices.

10. The apparatus of claim 9, wherein the one or more application server components associate the call with the one or more interactions available, wherein the one or more application server components provide the one or more interactions available that allow the telephony devices to initiate the one or more user inputs from the one or more available interactions.

11. The apparatus of claim 8, wherein the one or more application server components comprise a first application server component and a second application server component, wherein the one or more telephony devices comprise a first telephony device and a second telephony device;
wherein the first application server component provides one or more interactions available to the first telephony device that allow the first telephony device to initiate a user input from the one or more interactions available;
wherein in response to the user input from the first telephony device to the first application server component, the first application server component transmits the user input to the second application server component through employment of the one or more data streams;
wherein the second application server component provides the user input to the second telephony device.

12. The apparatus of claim 11, wherein the user input comprises a first user input of the one or more user inputs, wherein the second telephony device initiates a second user input to the first telephony device;
wherein the first application server component and the second application server component cooperate to transmit the second user input to the first application server component through employment of the one or more data streams;
wherein the first application server component provides the second user input to the first telephony device.

13. The apparatus of claim 2, wherein the one or more user inputs comprise one or more sales interactions, wherein the one or more telephony devices comprise a first telephony device and a second telephony device;
wherein the one or more application server components provide the one or more sales interactions that allow the first telephony device to initiate one or more of the one or more sales interactions to the second telephony device;
wherein the one or more application server components cooperate to transmit the one or more of the one or more sales interactions from the first telephony device to the second telephony device through employment of the one or more data streams.

14. The apparatus of claim 13, wherein the one or more sales interactions comprise a request for authorization, wherein the one or more application server components provide the one or more sales interactions that allow the first telephony device to initiate the request for authorization to the second telephony device;
wherein in response to the request for authorization from the first telephony device to the first application server component, the first application server component transmits the request for authorization to the second application server component through employment of the one or more data streams;
wherein the second application server component provides the request for authorization to the second telephony device that allows the second telephony device to initiate a response to the request for authorization.

15. The apparatus of claim 2, wherein the one or more user inputs comprise one or more support interactions, wherein the one or more telephony devices comprise a first telephony device and a second telephony device;
wherein the one or more application server components provide the one or more support interactions that allow the first telephony device to initiate one or more of the one or more support interactions to the second telephony device;
wherein the one or more application server components cooperate to transmit the one or more of the one or more support interactions to the second telephony device through employment of the one or more data streams.

16. The apparatus of claim 15, wherein the one or more support interactions comprise a diagnostic service, wherein the one or more application server components provide the one or more support interactions to allow a user of the first telephony device to initiate the diagnostic service to the second telephony device;
wherein in response to the diagnostic service from the first telephony device to the one or more application server components, the one or more application server components transmit the diagnostic service to the second telephony device through employment of the one or more data streams;
wherein the one or more application server components provide the diagnostic service to the second telephony device that allows the first telephony device to interact with the second telephony device.

17. A method, comprising the step of:
transmitting one or more user inputs to one or more telephony devices on a call through employment of one or more data streams associated with the call.

18. The method of claim 17, wherein the step of transmitting the one or more user inputs the one or more telephony devices on the call through employment of the one or more data streams associated with the call comprises the steps of:
establishing one or more web portals with the one or more telephony devices;
initiating the one or more user inputs through employment of the one or more web portals; and
transmitting the one or more user inputs through employment of the one or more data streams.

19. The method of claim 18, wherein the one or more telephony devices comprise a first telephony device and a second telephony device, wherein the step of transmitting the one or more user inputs through employment of the one or more data streams comprises the steps of:
associating the one or more web portals with the call; and
associating the one or more web portals with the one or more data streams.

20. An article, comprising:
one or more computer-readable signal-bearing media;
means in the one or more media for transmitting one or more user inputs to one or more telephony devices on a call through employment of one or more data streams associated with the call.
